(19) United States
(12) Patent Application Publication
(10) Pub. No.: US 2018/0246632 A1
(43) Pub. Date: Aug. 30, 2018

(54) METHOD AND DEVICE FOR GENERATING MOBILE TERMINAL THEME, AND ELECTRONIC DEVICE

(71) Applicant: BEIJING KINGSOFT INTERNET SECURITY SOFTWARE CO., LTD., BEIJING (CN)

(72) Inventors: Ji TANG, BEIJING (CN); Qinchong FENG, BEIJING (CN)

(21) Appl. No.: 15/754,321

(22) PCT Filed: Aug. 16, 2016
(86) PCT No.: PCT/CN2016/095460

§ 371 Date: Feb. 22, 2018

(30) Foreign Application Priority Data
Aug. 27, 2015 (CN) 201510536319.0

(51) Int. Cl. G06F 3/0481; G06F 3/0484

(52) U.S. Cl. CPC G06F 3/04817; G06F 3/04845

(57) ABSTRACT

Disclosed in an embodiment of the application are a method and device for generating a mobile terminal theme. The method includes: determining a target wallpaper picture, and determining a target icon style; displaying an icon conforming to the target icon style in a preset preview area of the target wallpaper picture; receiving a theme completing instruction sent by a user; and generating and storing a target theme composed of the target wallpaper picture and the target icon style. The present disclosure further provides an electronic device.

### CROSS-REFERENCE TO RELATED APPLICATIONS

This application is a U.S. national phase application based upon International Application No. PCT/CN2016/095460, filed on Aug. 16, 2016, which claims priority to and benefits of Chinese Patent Application No. 201510536319.0, filed with the State Intellectual Property Office of P.R. China on Aug. 27, 2015, and titled with “METHOD AND DEVICE FOR GENERATING MOBILE TERMINAL THEME”, the entire contents of which are incorporated herein by reference.

### FIELD

The present disclosure relates to an internet technology field, and more particularly, to a method and a device for generating a mobile terminal theme, and an electronic device.

### BACKGROUND

Nowadays, a mobile terminal has become an important tool in people's work and life. With the increasing focus of users on a desktop presentation of the mobile terminal and the display style of an application icon, a mobile terminal theme has emerged. The mobile terminal theme refers to an interface style of the mobile terminal desktop, which includes the desktop wallpaper and the icon display style. The mobile terminal theme is a visual extension and a visual effect to the user.

At present, most of the mobile terminal themes are designed by a professional designer, when the user changes the mobile terminal theme, the user can select a desired theme from a theme library, so as to change the mobile terminal theme.

By applying this method for generating the mobile terminal theme, the user can only select a corresponding theme from the theme library. However, the wallpaper picture and the icon style in the theme are fixed, and cannot be changed even if the user is not satisfied with one of them, which is difficult to satisfy diversified and personalized requirements of the user.

### SUMMARY

Embodiments of the present disclosure provide a method and a device for generating a mobile terminal theme. Technical solutions are described as follows.

A method for generating a mobile terminal theme is provided, and the method is applied to a mobile terminal. The method includes: determining a target wallpaper picture and determining a target icon style; displaying an icon conforming to the target icon style in a preset preview area of the target wallpaper picture; receiving a theme completing instruction sent by a user; and generating and storing a target theme composed of the target wallpaper picture and the target icon style.

A device for generating a mobile terminal theme is provided, and the device is applied to a mobile terminal. The device includes a wallpaper picture determining module, configured to determine a target wallpaper picture, an icon style determining module, configured to determine a target icon style, a preview displaying module, configured to display an icon conforming to the target icon style in a preset preview area of the target wallpaper picture, a completing instruction receiving module, configured to receive a theme completing instruction sent by a user, and a target theme generating module, configured to generate and store a target theme composed of the target wallpaper picture and the target icon style.

An electronic device is provided, in which, the electronic device includes a processor, a memory, a communication interface and a bus. The processor, the memory and the communication interface are connected via the bus and communicate with each other. The memory is configured to store an executable program code. The processor is configured to execute a program corresponding to the executable program code by reading the executable program code stored in the memory to execute a method for generating a mobile terminal theme as mentioned above.

A storage medium is provided, in which, the storage medium is configured to store executable program codes, and the executable program codes are configured to execute the method for generating a mobile terminal theme as mentioned above at run time.

An application program is provided, in which, the application program is configured to execute the method for generating a mobile terminal theme as mentioned above at run time.

### BRIEF DESCRIPTION OF THE DRAWINGS

In order to clearly illustrate technical solutions of embodiments of the present disclosure, a brief description of drawings used in embodiments is given below. Obviously, the drawings in the following descriptions are only part embodiments of the present disclosure, and for those skilled in the art, other drawings can be obtained according to these drawings without creative labor.

FIG. 1 is a flow chart of a method for generating a mobile terminal theme according to an embodiment of the present disclosure.

FIG. 2a is a schematic diagram of a mobile terminal theme according to an embodiment of the present disclosure.

FIG. 2b is a schematic diagram of a mobile terminal theme according to another embodiment of the present disclosure.

FIG. 3 is a block diagram of a device for generating a mobile terminal theme according to an embodiment of the present disclosure.

FIG. 4 is a block diagram of an electronic device according to an embodiment of the present disclosure.

### DETAILED DESCRIPTION

In order to enable those skilled in the art to understand the technical solutions of the present disclosure, reference will be made clearly and completely to technical solutions in the embodiments of the present disclosure with accompanying drawings. Obviously, the embodiments described here are only part of the embodiments of the present disclosure and are not all embodiments of the present disclosure. Based on the embodiments of the present disclosure, other embodiments obtained by those skilled in the art without creative labor are within the scope of the present disclosure.

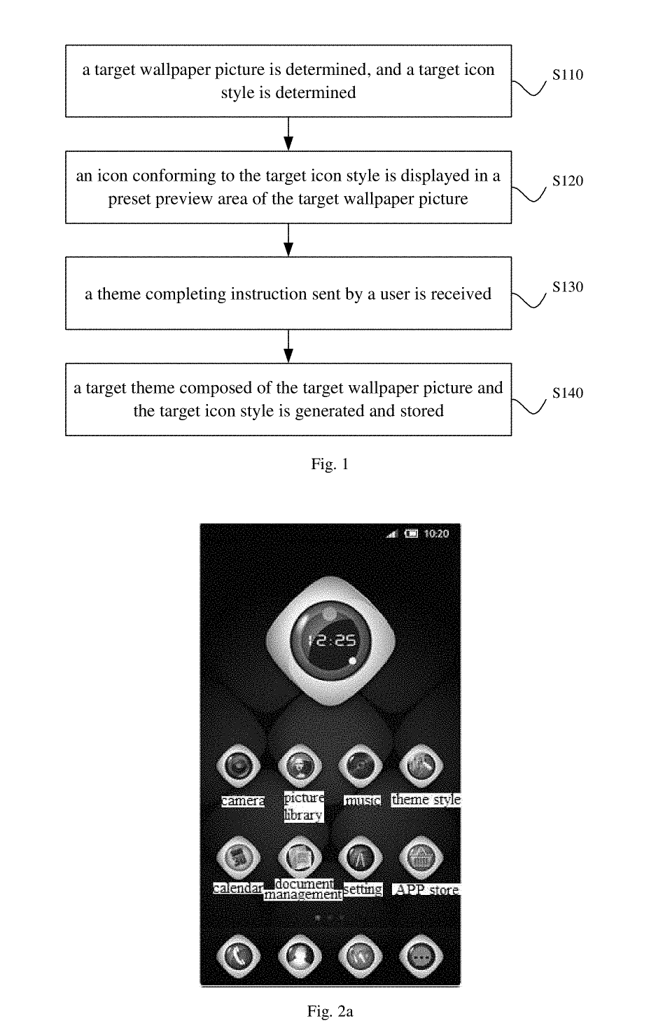

Referring to FIG. 1, FIG. 1 is a flow chart of a method for generating a mobile terminal theme according to an embodiment of the present disclosure. The method is applied to a mobile terminal and includes followings.

At block S110, a target wallpaper picture is determined, and a target icon style is determined.

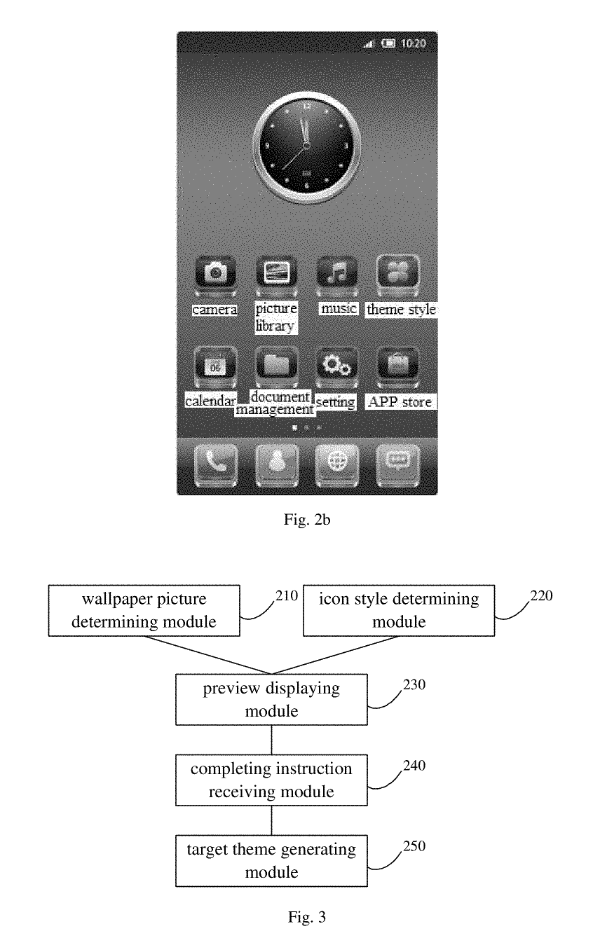

The mobile terminal theme includes a wallpaper picture of a mobile terminal desktop and an icon style of an icon for each application or function item in the mobile terminal. FIG. 2a and FIG. 2b are schematic diagrams of a mobile terminal using different themes.

Technical solutions provided by embodiments of the present disclosure can be applied to a scene where a user makes the mobile terminal theme by himself/herself (i.e., DIY). For example, in an Android system, a DIY module may be provided in a launcher (a desktop launcher in the Android system), and the IDY module is configured to allow the user to make the theme by himself/herself. In this way, the user can select the wallpaper picture and the icon style according to his/her own preference, so that the theme can conform to his/her own aesthetic standard.

In a practical application, a theme making button can be provided to the user, and when the user has a need for making the theme by himself/herself, the user can click the corresponding theme making button. When the mobile terminal detects that the user clicks the theme making button, it is deemed to receive a theme making instruction of the user. Furthermore, the user can be guided to select the wallpaper picture and the icon style, the user can select the wallpaper picture and the icon style according to his/her own preference, and the mobile terminal can determine the target wallpaper picture and target icon style according to selections of the user.

It should be noted that, in the practical application, the target wallpaper picture can be determined first, and then target icon style is determined. Alternatively, the target icon style can be determined first, and then the target wallpaper picture is determined. Embodiments of the present disclosure are not limited thereto.

At block S120, an icon conforming to the target icon style is displayed in a preset preview area of the target wallpaper picture.

In a theme making interface that is provided for the user by the mobile terminal, a preview area can be preset. After the mobile terminal determines the target wallpaper picture according to the wallpaper picture selected by the user, the target wallpaper picture can be displayed in the preview area Similarly, after the mobile terminal determines the target icon style according to the icon style selected by the user, the icon conforming to the target icon style can be displayed in the preview area of the target wallpaper picture.

A location of the preview area can be set according to an actual situation. For example, the preview area may be in the middle of the theme making interface. When the user selects a certain picture and takes it as the wallpaper picture, the wallpaper picture can be displayed in the preview area. When the user selects a certain icon style, the icon(s) conforming to the icon style can be displayed in the preview area of the wallpaper picture.

The mobile terminal presents a preview effect of the target wallpaper picture and the icon conforming to the target icon style (that is, the preview effect of the theme to be generated) to the user in the preview area. The user can view whether the selected target wallpaper picture is matched with the target icon style and determine whether the preview effect meets his/her own expectation through the preview effect presented in the preview area.

When the preview effect meets the expectation of the user, the user can send a theme completing instruction to the mobile terminal, and the mobile terminal may continue to perform an operation at block S130. When the preview effect does not meet the expectation of the user, the user can reselect the wallpaper picture through a wallpaper picture selection interface, alternatively, the user can reselect the icon style through an icon style selection interface, so that the mobile terminal can re-determine the target wallpaper picture and the target icon style according to the selections of the user, and display the icon(s) conforming to the target icon style in the preset preview area of the target wallpaper picture for the user to confirm again.

At block S130, a theme completing instruction sent by a user is received.

In the practical application, the mobile terminal may provide the user with a theme making completing button. When the preview effect of the icon(s) conforming to the target icon style displayed in the preview area of the target wallpaper picture meets the expectation of the user, the user can click the theme making completing button. When the mobile terminal detects that the user clicks the button, it is deemed to receive the theme completing instruction of the user, and an operation at block S140 can be executed.

At block S140, a target theme composed of the target wallpaper picture and the target icon style is generated and stored.

After the theme completing instruction sent by the user is received, the target theme composed of the target wallpaper picture and the target icon style can be generated, and the mobile terminal can store the target theme in a theme library according to a preset storage rule, at the end, the user completes making the DIY theme.

By applying the technical solutions provided by embodiments of the present disclosure, after the mobile terminal determines the target wallpaper picture and the target icon style, the icon conforming to the target icon style is displayed in the preset preview area of the target wallpaper picture. When the user is satisfied with the display effect of the preview area, the user can send the theme completing instruction to the mobile terminal, and the mobile terminal can generate and store the target theme composed of the target wallpaper picture and the target icon style after receiving the theme completing instruction of the user, thereby satisfying a personalized requirement of the user.

In the practical application, the mobile terminal can provide the user with selection entrance buttons for two types of pictures in the wallpaper picture selection interface, in which, one type of pictures refers to local pictures, and the other type of pictures refers to online pictures. The user can click the selection entrance button for one type of pictures according to needs to select a corresponding picture as the wallpaper picture.

In an embodiment of the present disclosure, the target wallpaper picture can be determined by following steps.

At step one, a local picture library is opened according to an instruction for selecting a local picture of the user.

At step two, the local picture selected by the user is determined as the target wallpaper picture.

When the user clicks the selection entrance button for the local pictures, the mobile terminal can receive the instruction for selecting the local picture from the user. The mobile terminal can open the local picture library such as a local album for the user according to the instruction for selecting the local picture of the user, and the user can select a local picture from the local picture library. The mobile terminal determines the local picture selected by the user as the target wallpaper picture.

In an embodiment of the present disclosure, the target wallpaper picture can be determined by following acts.

At step one, an online wallpaper thumbnail is displayed to the user according to an instruction for selecting an online picture of the user.

At step two, a request for a wallpaper picture corresponding to the online wallpaper thumbnail selected by the user is sent to a server.

At step three, the wallpaper picture returned by the server is determined as the target wallpaper picture.

When the user clicks a selection entrance button for the online pictures, the mobile terminal can receive the instruction for selecting the online picture from the user. The mobile terminal can display the online wallpaper thumbnail(s) to the user according to the instruction for selecting the online picture of the user.

In the practical application, the mobile terminal may cache the online wallpaper thumbnail(s), and directly display the online wallpaper thumbnail(s) to the user when the mobile terminal receives the instruction for selecting the online picture of the user. Certainly, when there is no cached online wallpaper thumbnail in the mobile terminal, or the cached online wallpaper thumbnail in the mobile terminal is expired, the mobile terminal may request the server for the online wallpaper thumbnail(s) and display the online wallpaper thumbnail(s) to the user when the mobile terminal receives the instruction for selecting the online picture of the user.

The user can select a thumbnail from the online wallpaper thumbnails displayed by the mobile terminal according to personal preference, and the mobile terminal requests the server for the wallpaper picture corresponding to the thumbnail, and determines the wallpaper picture returned by the server as the target wallpaper picture.

The online wallpaper pictures stored in the server may be updated regularly, such that variety of online wallpaper pictures can satisfy personalized requirements of more users.

In an embodiment of the present disclosure, the target icon can be determined by following acts.

At step one, an icon style thumbnail is displayed to the user according to an instruction for selecting an icon style of the user.

At step two, a request for the icon style corresponding to the icon style thumbnail selected by the user is sent to the server.

At step three, the icon style returned by the server is determined as the target icon style.

When the user needs to select the icon style, the mobile terminal can display the icon style thumbnail(s) to the user in the icon style selection interface according to the instruction for selecting the icon style of the user.

In the practical application, the mobile terminal may cache the icon style thumbnail(s), and directly display the icon style thumbnail(s) to the user when the mobile terminal receives the instruction for selecting the icon style of the user. Certainly, when there is no cached icon style thumbnail in the mobile terminal, or the cached icon style thumbnail in the mobile terminal is expired, the mobile terminal may request the server for the icon style thumbnail(s) and display the icon style thumbnail(s) to the user when the mobile terminal receives the instruction for selecting the icon style of the user.

The user can select a thumbnail from the icon style thumbnails displayed by the mobile terminal according to the personal preference, and the mobile terminal requests the server for the icon style corresponding to the thumbnail and determines the icon style returned by the server as the target icon style.

The icon style stored in the server may be updated regularly, such that variety of icon styles can satisfy personalized requirements of more users.

In an embodiment of the present disclosure, the act at block S120 may include followings.

At a first step, the target wallpaper picture is cropped according to an aspect ratio of a screen of the mobile terminal.

At a second step, a cropped target wallpaper picture is displayed in the preset preview area, and the icon conforming to the target icon style is displayed in the preset preview area.

The terminal screens of different mobile terminals have different aspect ratios, and after the target wallpaper picture and the target icon style are determined, the target wallpaper picture can be cropped according to the aspect ratio of the terminal screen. In detail, a crop box with the same aspect ratio as the terminal screen can be provided in the target wallpaper picture, and the crop box is adjusted by the user. The mobile terminal crops the target wallpaper picture according to the adjustment of the user, and displays the cropped target wallpaper picture in the preset preview area, and displays the icon conforming to the target icon style in the preset preview area.

In an embodiment of the present disclosure, after a theme completing instruction sent by the user is received in block S130, the method may further include the following.

An applying instruction for the target theme sent by the user is received, and the target theme is applied.

In the practical application, after the user completes making the target theme, the user can send the applying instruction for the target theme to the mobile terminal to apply the target theme.

Alternatively, after the user completes making the target theme and the target theme is stored in the theme library, the user can send the applying instruction for the target subject to the mobile terminal to apply the target theme.

In an embodiment of the present disclosure, after a theme completing instruction sent by the user is received in block S130, the method may further include the following.

A sharing instruction for the target theme sent by the user is received, and the target theme is shared with other users.

In the practical application, after the user completes making the target theme, the user can send the sharing instruction for the target theme to the mobile terminal to share the target theme with the other users.

Alternatively, after the user completes making the target theme and the target theme is stored in the theme library, the user can send the sharing instruction for the target theme to the mobile terminal to share the target theme with the other users.

In detail, the user can share the target theme with social friends, or can upload the target theme to a personal network space or a server to share it with other users.

In an embodiment of the present disclosure, regarding specific technical implementations, reference can be made to following examples.

When the user needs to select the icon style, the mobile terminal can request the icon style asynchronously in a function onCreate( ). Before the mobile terminal requests the server for data of the icon style, the mobile terminal can check whether there is cached icon style thumbnail in local first. When there is cached icon style thumbnail, it is determined whether the cached icon style thumbnail is expired, when the cached icon style thumbnail is expired, the mobile terminal can request the server to return the icon style thumbnail, and when the cached icon style thumbnail is not expired, the mobile terminal can directly display the local cached icon style thumbnail to the user.

The icon style thumbnail that is cached by the mobile terminal can be cached in a secure digital memory card, and saved content is an entire class CacheAble. This class needs to implement an interface Serializable. Server time, cache time and icon style models are stored in the class CacheAble. When a duration difference between the cache time and system current time obtained by System.currentTimeMillis( ) is greater than a preset cache expiration duration, it can be deemed that the icon style thumbnail is expired.

When the icon style thumbnail that is cached by the mobile terminal is expired, the mobile terminal can send the request to the server. After the data corresponding to the icon style thumbnail returned by the server is received, the data is parsed, the CacheAble is generated, the icon style thumbnail is stored locally, and the cache time is recorded.

When the user needs to select the wallpaper picture, the mobile terminal can call a function startActivityForResult of an Activity, and it will enter a function onActivityResult (int requestCode, int resultCode, intent data) of the Activity of the theme after the user selects the wallpaper picture from other Activities. The mobile terminal determines whether the user selects the wallpaper picture by determining whether the data is null and determines the wallpaper picture selected by the user as the target wallpaper picture.

After the target wallpaper picture is determined, the mobile terminal can generate a preview that is consistent with the aspect ratio of the terminal screen, and store a wallpaper picture with the same width and height as the screen asynchronously in a predefined folder, and at the same time, the mobile terminal informs a UI thread to update the ImageView, and calls a function setBackGround( ) to set a background.

After the target icon style is determined, the mobile terminal can obtain information of the currently selected icon style, and obtain a URL of a preview picture from the information of the icon style, and then request the URL asynchronously to obtain the preview picture. When the preview picture is obtained successfully, the mobile terminal can inform the UI thread to update ImageView and call a function setImageBitmap( ) to set a foreground.

When the user wants to store the target theme, the mobile terminal can obtain a URL for downloading an icon from the information of the currently selected icon style, download a zip file of the icon through the URL, uncompress the zip file to place the icon into the predefined folder, and store the target wallpaper picture and generated preview picture in this folder.

When the user wants to apply the target them, the launcher application obtains a configuration file from the folder corresponding to the target theme, reads the information of icon style from the configuration file, and replaces the icon or crops the icon, and obtains the wallpaper picture from the folder to set it as the desktop wallpaper.

Corresponding to the above method embodiments, embodiments of the present disclosure also provide a device for generating a mobile terminal theme, and the device is applied to a mobile terminal. Referring to FIG. 3, the device includes a wallpaper picture determining module 210, an icon style determining module 220, a preview displaying module 230, a completing instruction receiving module 240 and a target theme generating module 250.

The wallpaper picture determining module 210 is configured to determine a target wallpaper picture.

The icon style determining module 220 is configured to determine a target icon style.

The preview displaying module 230 is configured to display an icon conforming to the target icon style in a preset preview area of the target wallpaper picture.

The completing instruction receiving module 240 is configured to receive a theme completing instruction sent by a user.

The target theme generating module 250 is configured to generate and store a target theme composed of the target wallpaper picture and the target icon style.

By applying the device provided by embodiments of the present disclosure, after the mobile terminal determines the target wallpaper picture and the target icon style, the icon conforming to the target icon style is displayed in the preset preview area of the target wallpaper picture. When the user is satisfied with the display effect of the preview area, the user can send the theme completing instruction to the mobile terminal, and the mobile terminal can generate and store the target theme composed of the target wallpaper picture and the target icon style after receiving the theme completing instruction of the user, thereby satisfying the personalized requirement of the user.

In an embodiment of the present disclosure, the wallpaper picture determining module 210 is further configured to open a local picture library according to an instruction for selecting a local picture of the user, and determine the local picture selected by the user as the target wallpaper picture.

In an embodiment of the present disclosure, the wallpaper picture determining module 210 is further configured to display an online wallpaper thumbnail to the user according to an instruction for selecting an online picture of the user, send a request for a wallpaper picture corresponding to the online wallpaper thumbnail selected by the user to a server, and determine the wallpaper picture returned by the server as the target wallpaper picture.

In an embodiment of the present disclosure, the icon style determining module 220 is further configured to display an icon style thumbnail to the user according to an instruction for selecting the icon style of the user, send a request for an icon style corresponding to the icon style thumbnail selected by the user to a server, and determine the icon style returned by the server as the target icon style.

In an embodiment of the present disclosure, the preview displaying module 230 is further configured to crop the target wallpaper picture according to an aspect ratio of a screen of the mobile terminal, and display a cropped target wallpaper picture in the preset preview area and display the icon conforming to the target icon style in the preset preview area.

In an embodiment of the present disclosure, the device further includes a theme applying module, and/or a theme sharing module.

The theme applying module is configured to receive an applying instruction for the target theme sent by the user, and apply the target theme.

The theme sharing module is configured to receive a sharing instruction for the target theme sent by the user, and share the target theme with other users.

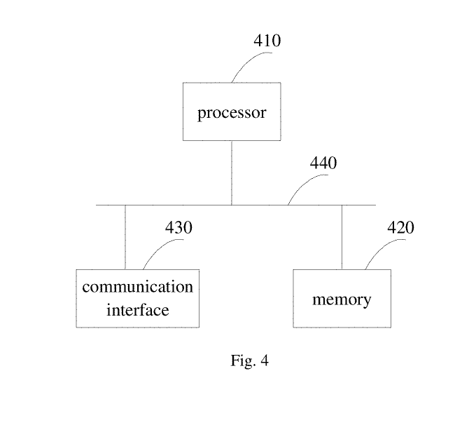

Accordingly, embodiments of the present disclosure further provide an electronic device. Referring to FIG. 4, the electronic device includes a processor 410, a memory 420, a communication interface 430 and a bus 440.

The processor 410, the memory 420 and the communication interface 430 are connected via the bus 440 and communicate with each other.

The memory 420 is configured to store an executable program code.

The processor 410 is configured to execute a program corresponding to the executable program code by reading the executable program code stored in the memory 420 to execute a method for generating a mobile terminal theme.

Accordingly, embodiments of the present disclosure further provide a storage medium. The storage medium is configured to store executable program codes, and the executable program codes are configured to execute the method for generating a mobile terminal theme at run time.

Accordingly, embodiments of the present disclosure further provide an application program. The application program is configured to execute the method for generating a mobile terminal theme at run time.

For embodiments of the device/the electronic device/the storage medium/the application program, since they are substantially similar to the method embodiments, descriptions of which are relatively simple, and relevant parts can refer to corresponding descriptions of the method embodiments.

It should be noted that, in descriptions of the present disclosure, terms such as “first” and “second” are only used for distinguishing an entity or operation from another entity or operation without necessarily requiring or implying any such actual relationship or order between these entities or operations. Furthermore, terms “comprising”, “containing” or any other variant thereof are intended to cover non-exclusive inclusion, such that the process, the method, the article or the device that includes a series of elements include those elements and other elements that are not listed explicitly, or include elements inherent in the process, the method, the article or the device. Without more restrictions, the elements defined by the phrase “including one . . . ” do not exclude the presence of additional similar elements in the process, the method, the article or the device that including the elements.

Each of embodiments in this specification is described in a related manner, and the same similar parts between the various embodiments may be referred to each other, and each embodiment is focused on differences from other embodiments. In particular, for the device embodiment, since it is substantially similar to the method embodiment, descriptions of which are relatively simple, and relevant parts can refer to corresponding descriptions of the method embodiments.

It would be understood by those skilled in the art that all or a part of the steps carried by the method in the above-described embodiments may be completed by relevant hardware instructed by a program. The program may be stored in a computer readable storage medium, and the storage medium herein may be ROM/RAM, magnetic disks, CD, etc.

The embodiments described above are merely preferred embodiments of the present disclosure, and is not intended to limit the scope of the present disclosure. Any modifications, equivalent alternatives, improvements and the like without departing from spirit and principles of the present disclosure are within the scope of the present disclosure.

1. A method for generating a mobile terminal theme, applied to a mobile terminal, comprising:
determining a target wallpaper picture, and determining a target icon style;
displaying an icon conforming to the target icon style in a preset preview area of the target wallpaper picture;
receiving a theme completing instruction sent by a user; and
generating and storing a target theme composed of the target wallpaper picture and the target icon style.

2. The method according to claim 1, wherein, determining the target wallpaper picture comprises:
opening a local picture library according to an instruction for selecting a local picture of the user; and
determining the local picture selected by the user as the target wallpaper picture.

3. The method according to claim 1, wherein, determining the target wallpaper picture comprises:
displaying an online wallpaper thumbnail to the user according to an instruction for selecting an online picture of the user;
sending a request for a wallpaper picture corresponding to the online wallpaper thumbnail selected by the user to a server; and
determining the wallpaper picture returned by the server as the target wallpaper picture.

4. The method according to claim 1, wherein, determining the target icon style comprises:
displaying an icon style thumbnail to the user according to an instruction for selecting an icon style of the user;
sending a request for an icon style corresponding to the icon style thumbnail selected by the user to a server; and
determining the icon style returned by the server as the target icon style.

5. The method according to claim 1, wherein, displaying the icon conforming to the target icon style in the preset preview area of the target wallpaper picture comprises:
cropping the target wallpaper picture according to an aspect ratio of a screen of the mobile terminal; and
displaying a cropped target wallpaper picture in the preset preview area, and displaying the icon conforming to the target icon style in the preset preview area.

6. The method according to claim 1, after receiving the theme completing instruction sent by the user, further comprising:
receiving an applying instruction for the target theme sent by the user, and applying the target theme.

7. A device for generating a mobile terminal theme, applied to a mobile terminal, comprising:
a processor;
a memory storing instructions executable by the processor;
wherein the processor is configured to:
determine a target wallpaper picture;
determine a target icon style;
display an icon conforming to the target icon style in a preset preview area of the target wallpaper picture;
receive a theme completing instruction sent by a user; and
generate and store a target theme composed of the target wallpaper picture and the target icon style.

8. The device according to claim 7, wherein, the processor is further configured to determine the target wallpaper picture by:
opening a local picture library according to an instruction for selecting a local picture of the user; and
determining the local picture selected by the user as the target wallpaper picture.

9. The device according to claim 7, wherein, the processor is further configured to determine the target wallpaper picture by:
displaying an online wallpaper thumbnail to the user according to an instruction for selecting an online picture of the user;
sending a request for a wallpaper picture corresponding to the online wallpaper thumbnail selected by the user to a server; and
determining the wallpaper picture returned by the server as the target wallpaper picture.

10. The device according to claim 7, wherein, the processor is further configured to determine the target icon style by:
displaying an icon style thumbnail to the user according to an instruction for selecting an icon style of the user;
sending a request for an icon style corresponding to the icon style thumbnail selected by the user to a server; and
determining the icon style returned by the server as the target icon style.

11. The device according to claim 7, wherein, the processor is further configured to display the icon conforming to the target icon style in the preset preview area of the target wallpaper picture by:
cropping the target wallpaper picture according to an aspect ratio of a screen of the mobile terminal; and
displaying a cropped target wallpaper picture in the preset preview area and display the icon conforming to the target icon style in the preset preview area.

12. The device according to claim 7, wherein the processor is further configured to:
receive an applying instruction for the target theme sent by the user, and apply the target theme.

13. An electronic device, comprising:
a processor, a memory, a communication interface and a bus; wherein,
the processor, the memory and the communication interface are connected via the bus and communicate with each other;
the memory is configured to store an executable program code;
the processor is configured to execute a program corresponding to the executable program code by reading the executable program code stored in the memory to execute a method for generating a mobile terminal theme comprising:
determining a target wallpaper picture, and determining a target icon style;
displaying an icon conforming to the target icon style in a preset preview area of the target wallpaper picture;
receiving a theme completing instruction sent by a user; and
generating and storing a target theme composed of the target wallpaper picture and the target icon style.

14.-15. (canceled)

16. The method according to claim 1, after receiving the theme completing instruction sent by the user, further comprising:
receiving a sharing instruction for the target theme sent by the user, and sharing the target theme with other users.

17. The device according to claim 7, wherein the processor is further configured to:
receive a sharing instruction for the target theme sent by the user, and share the target theme with other users.

18. The electronic device according to claim 13, wherein, determining the target wallpaper picture comprises:
opening a local picture library according to an instruction for selecting a local picture of the user; and
determining the local picture selected by the user as the target wallpaper picture.

19. The electronic device according to claim 13, wherein, determining the target wallpaper picture comprises:
displaying an online wallpaper thumbnail to the user according to an instruction for selecting an online picture of the user;
sending a request for a wallpaper picture corresponding to the online wallpaper thumbnail selected by the user to a server; and
determining the wallpaper picture returned by the server as the target wallpaper picture.

20. The electronic device according to claim 13, wherein, determining the target icon style comprises:
displaying an icon style thumbnail to the user according to an instruction for selecting an icon style of the user;
sending a request for an icon style corresponding to the icon style thumbnail selected by the user to a server; and
determining the icon style returned by the server as the target icon style.

21. The electronic device according to claim 13, wherein, displaying the icon conforming to the target icon style in the preset preview area of the target wallpaper picture comprises:
cropping the target wallpaper picture according to an aspect ratio of a screen of the mobile terminal; and
displaying a cropped target wallpaper picture in the preset preview area, and displaying the icon conforming to the target icon style in the preset preview area.

22. The electronic device according to claim 13, after receiving the theme completing instruction sent by the user, further comprising:
receiving an applying instruction for the target theme sent by the user, and applying the target theme.
